(19) United States
(12) Patent Application Publication
(10) Pub. No.: US 2001/0036130 A1
(43) Pub. Date: Nov. 1, 2001

(54) Cranial nerve clock and watch

(76) Inventor: Richard Loria, McLean, VA (US)

Correspondence Address: Smith, Gambrell & Russell, LLP, Suite 800, 1850 M Street, N.W., Washington, DC, 20036, US

(21) Appl. No.: 09/808,122

(22) Filed: Mar. 15, 2001

Related U.S. Application Data
(60) Provisional application No. 60/189,871, filed on Mar. 16, 2000.

(51) Int. Cl. G04C 17/00; G04B 19/00; G04B 25/00

(52) U.S. Cl. 368/223

(57) ABSTRACT

The cranial nerve clock and watch is meant to be a readily accessible, and useful, visual aid to unravel the difficulties in memorizing the twelve cranial nerves. The device is both aesthetically pleasing and useful as a chronometer.

### RELATED APPLICATIONS

This application claims priority to U.S. Provisional Application No. 60/189,871 filed on Mar. 16, 2000.

### BACKGROUND OF THE INVENTION

The present invention relates to clocks and watches, noted for their aesthetic quality, that are also useful as memory devices.

The twelve cranial nerves are memorized by medical students worldwide. Other medical practitioners, such as nurses also memorize the cranial nerves. A memorized study of the twelve cranial nerves is finds utility in the field of neurology and primary care medicine. Veterinary students must also remember the same set of cranial nerves in higher mammals. This invention has applicability to veterinary personnel as well. Accordingly, the cranial nerve clock and watch device may also find utility in the study of all animals with the twelve cranial nerves.

There have been numerous pneumonic devices assist in memorization of the twelve cranial nerves. The best known of these is “On Old Olympus' Towering Top A Finn And German Viewed All Hops”. However, this pneumonic still requires a “translation” from the above pneumonic to the actual names of the cranial nerves themselves; namely the Olfactory, Ophthalmic, Oculomotor, Trochlear, Trigeminal, Abducens, Facial, Auditory, Glossopharyngeal, Vagus, Accessory and Hypoglossal nerves. In addition, there is no visual aid to assist in formulating a fill recitation of all twelve nerves.

### SUMMARY OF THE INVENTION

The cranial nerve clock and watch is meant to be a readily accessible, and useful, visual aid to unravel the difficulties in memorizing this information. The device is both aesthetically pleasing and useful as a chronometer.

The clock or watch incorporates symbolic images of the twelve cranial nerves into the twelve hours on the face of a watch or clock. Each cranial nerve illustrative image can be situated on the watch or clock corresponding to its associated hour. For instance, the Olfactory cranial nerve image can be situated at one o'clock, the Ophthalmic cranial nerve image can be situated at two o'clock, etc. In addition to the location of each cranial nerve, the watch can incorporate colors corresponding to which cranial nerve is motor, sensory or both motor and sensory.

Another variant of the invention involves the areas of the brain stem from which the different nerves originate. The symbolic images can be color coded and the watch face can be divided along this color scheme to indicate whether the nerve arises from the midbrain, pons, or mesencephalon.

The hour hand can be designed in the shape of a reflex hammer and the minute hand a simple watch hand or a neuron. There can also be a sweep second hand to count pulse, which is a regular practice of those most expected to take advantage of this invention.

The watch crystal covering the watch can be ordinary glass or magnification glass to amplify the images in a similar manner to the magnifying glass often present over the date on a watch.

### BRIEF DESCRIPTION OF THE FIGURES

FIG. 1 is a front view of a chronometer face according to the invention.

### DETAILED DESCRIPTION

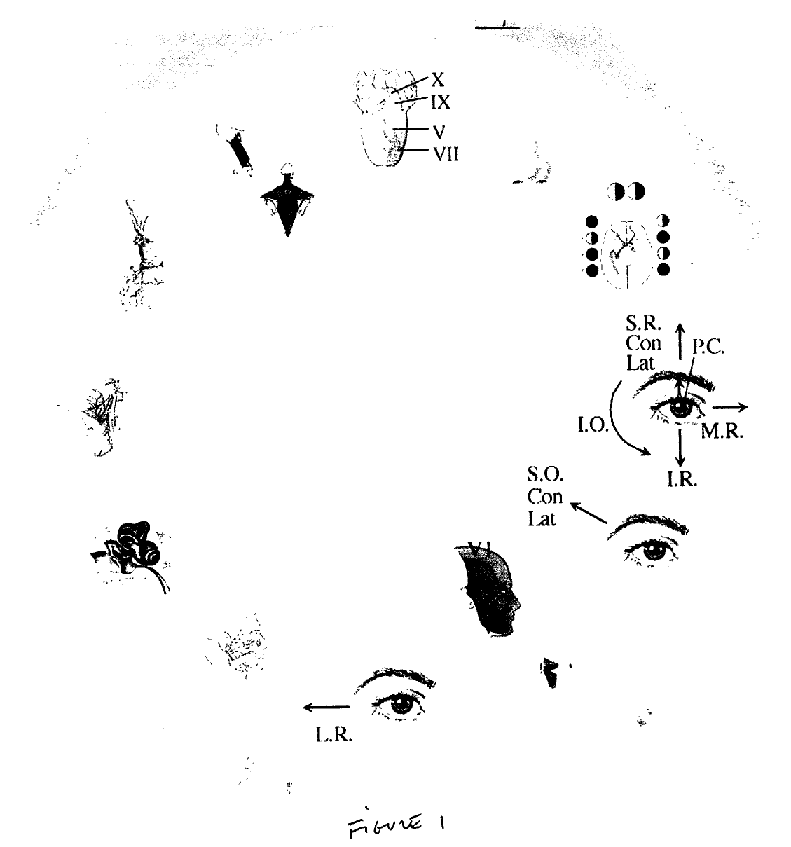

The twelve cranial nerves can be placed in any order on the face of the chronometer. One embodiment exemplifies the best known sequence corresponding the traditional pneumonic and is described below. The symbolic image for each is positioned on the face of the watch or clock the image would occupy according to the pneumonic: “On Old Olympus' Towering Top A Finn And German Viewed All Hops.” References to the following as nerve one, nerve two, and on, are meant to depict the position on the clock face in which the illustrative images appear in FIG. 1.

ONE O'CLOCK

Cranial nerve one is the Olfactory Nerve. It carries the sense of smell. The image at the one o'clock site involves a nose. This image depicts that the sense of smell is carried by cranial nerve one.

TWO O'CLOCK

Cranial nerve two is the Ophthalmic Nerve. It carries the sense of vision. The image at the two o'clock site involves pathway of the optic nerve in the brain with the visual fields depicted. This image depicts that the sense of vision is carried by this cranial nerve.

THREE O'CLOCK

Cranial nerve three is the Oculomotor Nerve. This nerve is responsible for motor control of the muscles of the eye ball, pupillary constriction, and elevation of the eye lid. The image at the three o'clock site is an external, forward view of the eye with several arrows and initials associated. To the right of the eye is a small arrow pointing to the right. The initials M.R. indicate that the third cranial nerve controls the Medial Rectus muscle which adducts the eye ball. Inferior to the eye ball is an arrow pointing downward. This arrow and the initials I.R. indicate that this cranial nerve controls the Inferior Rectus muscle which moves the eye in a downward direction.

To the left of the eye ball is a curved arrow with the direction of the arrow curving down and toward the midline of the body. The initials I.O. next to this arrow indicate that this cranial nerve innervates the Inferior Oblique muscle which rotates the eye ball downward and inward.

Above the eye there is a vertical arrow directed upward. The initials S. R. CON LAT there indicate that this cranial nerve innervated the CONTRA-LATERAL Superior Rectus muscle. This, more specifically, indicates that these nerve fibers as they innervate the Superior Rectus muscles decussate, or “cross over.” The small arrow located on the upper eye lid going in an upward direction indicates that this cranial nerve innervates the muscles which elevate the eye lid. While this nerve transfers signals to elevate the eye lid, it is the Facial Nerve, the seventh cranial nerve according to this embodiment, which is responsible for closing the eye lids.

Also, there line going from the pupil, with the letters P.C. indicates that Pupillary Constriction is also controlled by the Oculomotor Nerve via the ciliary apparatus.

FOUR O'CLOCK

Cranial nerve four is the Trochlear Nerve. This nerve innervates the Superior Oblique muscle. The image is an external forward view of the eye with one arrow directed upward and outward. The initials S.O., next to the arrow, illustrates that this cranial nerve innervates the Superior Oblique muscle which moves the eye in an upward and outward direction.

FIVE O'CLOCK

Cranial nerve five is the Trigeminal Nerve. There are two images at the five o'clock site. The outermost image is a skull with a muscle featured at the external angle of the jaw. This image depicts the Masseter muscle and illustrates that the Trigeminal Nerve innervates the muscles of mastication or chewing.

The Trigeminal Nerve innervates more than just the external masseter. Because of size and space limitations, not all the muscles which this nerve innervates can be conveniently depicted. The image is sufficient to illustrate that the Trigeminal Nerve innervates the muscles of mastication.

The innermost image is that of a lateral view of the head. This image is used to illustrate the sensory pattern of innervation of Trigeminal Nerve. There can be different colors shown on this image indicating different zones. Only three of the zones are overlayed with letters and numbers.

The uppermost zone which in this rendition is a light blue is overlayed with the designation “v1”. This is to indicate that ophthalmic branch of the trigeminal nerve innervates this zone of the head and face. The color of this first section extends to the tip of the nose. This indicates that the Ophthalmic branch of the Trigeminal Nerve innervates this particular part of the face. This ophthalmic branch innervates the tip of the nose as any involvement of this area of skin such as with Herpes Zoster, may indicate involvement of the cornea which might result in blindness.

The second zone in this rendition is over-layed with the designation “v2”. This indicates that the maxillary branch of the Trigeminal Nerve innervates this area of the face. The third zone in this image is overplayed with the designation “v3” to indicate that the Mandibular branch of the Trigeminal Nerve innervates this area of the face.

SIX O'CLOCK

Cranial nerve six is the Abducens Nerve. The image is an external forward view of the eye with one arrow directed laterally, that is away from the mid-line of the body. The initials L.R. appear adjacent to the arrow. This image illustrates that the sixth cranial nerve innervates the Lateral Rectus muscle which abducts the eye ball.

SEVEN O'CLOCK

Cranial nerve seven is the Facial Nerve. The image is a lateral view of the head and neck. The muscles innervated by the Facial Nerve and can be coded by color. The image illustrates that this cranial nerve innervates facial muscles found not only on the face but more specifically around the eyes, mouth and then extending down onto the neck.

EIGHT O'CLOCK

Cranial nerve eight is the Auditory Nerve. The image shown is that of the middle and inner ear with the semicircular canals of the vestibular apparatus clearly depicted as well as the cochlea of the auditory portion of this nerve. The image demonstrates that this cranial nerve innervates both the auditory and the vestibular components of this sensory organ.

NINE O'CLOCK

Cranial nerve nine is the Glossopharyngeal Nerve. The image shown is a sagittal section of the head and neck. The areas depicted in red are the mucosal membranes of the nose and throat. This image is designed to demonstrate that the Glossopharyngeal Nerve innervates the Nasopharyngeal mucosas.

TEN O'CLOCK

Cranial nerve ten is the Vagus Nerve. The Vagus Nerve has a very broad distribution, hence there are three images at this site. One image is of the external ear. A second image is of the gastrointestinal tract from the esophagus all the way to the colon. The third image at the ten o'clock location is of the Trachea and it's bifurcation, as well as the Lungs. These images are meant to illustrate this cranial nerve innervates vast areas and structures in the respiratory and gastrointestinal tract as well as a part of the external ear.

ELEVEN O'CLOCK

Cranial nerve eleven is the Accessory Nerve, also known as the Spinal Nerve. There are two images at this site. One image depicts the Sternocleidomastoid muscle and the other depicts the Trapezius muscle. One version of the watch can depict a posterior view of the Trapezius muscle and another version can depict a lateral view of the Trapezius muscle. The Sternocleidomastoid muscle and the Trapezius muscle can be depicted in color over skeletal images of the head, neck, and upper chest. These images illustrate that the Accessory Nerve innervates both of these muscles.

TWELVE O'CLOCK

Cranial nerve twelve is the Hypoglossal Nerve. The image depicts the dorsal aspect of the tongue. Also included in this image are four lines which extend laterally and are labeled by roman numerals X, IX, V, and VII. This image illustrates that motor control of the muscles of the tongue is via this cranial nerve. The roman numerals are meant to indicate that there are other nerves which innervate specific parts of the tongue as shown.

While the invention has now been described in terms an embodiment, and exemplified with respect thereto, the skilled artisan will readily appreciate that various substitutions, changes, modifications, and omissions may be made without departing from the spirit thereof.

What is claimed:

1. A chronometer device, comprising a plurality of illustrative elements around a chronometer face, wherein each one of the illustrative elements depicts one of the twelve cranial nerves.

2. The device according to claim 1, wherein the illustrative elements are ordered around the perimeter of the chronometer face.

3. The device according to claim 2, wherein the illustrative elements display in a clockwise progression, the twelve cranial nerves according to the following sequence:
i) the olfactory nerve,
ii) the ophthalmic nerve,
iii) the oculomotor nerve,
iv) trochlear nerve,
v) the trigeminal nerve,
vi) the abducens nerve,
vii) the facial nerve,
viii) the auditory nerve,
ix) the glossopharyngeal nerve,
x) the vagus nerve,
xi) the accessory nerve, and
xii) the hypoglossal nerve.

4. The device according to claim 2, wherein the illustrative elements display in a clockwise progression, the twelve cranial nerves according to the following sequence:
i) the olfactory nerve,
ii) the ophthalmic nerve,
iii) the oculomotor nerve,
iv) trochlear nerve,
v) the trigeminal nerve,
vi) the abducens nerve,
vii) the facial nerve,
viii) the auditory nerve,
ix) the glossopharyngeal nerve,
x) the vagus nerve,
xi) the accessory nerve, and
xii) the hypoglossal nerve.
wherein the progression around the chronometer face initiates at the hourly site corresponding to one o'clock.

5. The device according to claim 1, wherein the illustrative elements are coded to signify the area of the brain stem from which the nerve originates, these areas selected from the group consisting of the midbrain, the pons, or the mesencephalon area.

6. The device according to claim 1, wherein the illustrative elements are coded to signify a cranial nerve that is selected from the classification consisting of:
a) motor only,
b) sensory only, and
c) both motor and sensory together.
